(19) United States
(12) Patent Application Publication
(10) Pub. No.: US 2011/0205173 A1
(43) Pub. Date: Aug. 25, 2011

(54) INPUT DEVICE AND ELECTRONIC APPARATUS

(75) Inventor: Kenji Arai, Nagano (JP)

(73) Assignee: SONY CORPORATION, Tokyo (JP)

(21) Appl. No.: 13/028,567

(22) Filed: Feb. 16, 2011

(30) Foreign Application Priority Data
Feb. 25, 2010 (JP) P2010-039783

(51) Int. Cl. G06F 3/041

(52) U.S. Cl. 345/173

(57) ABSTRACT

Disclosed herein is an input device, including: a protective substrate having a manipulation surface which an object to be detected contacts; a detection body in which a detection electrode is formed on a detection substrate facing a surface of the protective substrate opposite to the manipulation surface of the protective substrate; and a vibrating body which is fixed to the protective substrate and which is vibrated when the object to be detected contacts the manipulation surface.

### CROSS REFERENCES TO RELATED APPLICATIONS

The present application claims priority to Japanese Priority Patent Application JP 2010-039783 filed in the Japan Patent Office on Feb. 25, 2010, the entire content of which is hereby incorporated by reference.

### BACKGROUND

The present invention relates to the technique for detecting contact (a manipulation made by a user) made by an object to be detected, and more particularly to an input device which is capable of causing a user to perceive a sufficient manipulation feeling in a phase of the manipulation, and an electronic apparatus including the same.

In a flat plate type input device for detecting a manipulation made by a user, the technique for causing a user to perceive a manipulation feeling (clicking feeling) in a phase of the manipulation has been heretofore proposed. For example, an input device, using a resistance film system, for detecting presence or absence, and a position of a manipulation made by the user in accordance with conduction/insulation between conductive films formed on inner surfaces of a movable plate and a supporting substrate facing each other is proposed in Japanese Patent Laid-Open No. 2003-122507 (hereinafter referred to as Patent Document 1). With the technique described in Patent Document 1, a piezoelectric element fixed to a back surface of the supporting substrate located on a back side is vibrated in the phase of the manipulation, thereby causing the user to perceive the manipulation feeling (for example, refer to FIG. 7 in Patent Document 1).

### SUMMARY

Now, a construction is supposed such that a light transmissive protective substrate for protecting an input device is installed on a front surface side of the input device. However, when the protective substrate is added to the construction described in Patent Document 1 such that the piezoelectric element is fixed to the supporting substrate on the back surface side of the input device, the vibrations of the piezoelectric element are absorbed by constituent elements interposed between the piezoelectric element and a surface (a contact surface for the user) of the protective substrate. As a result, it becomes difficult to cause the user to perceive the sufficient manipulation feeling (vibrations). The present invention has been made in order to solve the problems described above, and it is therefore desirable to provide an input device which is capable of causing a user to perceive a sufficient manipulation feeling in a phase of the manipulation, and an electronic apparatus including the same.

In order to attain the desire described above, according to an embodiment of the present invention, there is provided an input device including: a protective substrate having a manipulation surface which an object to be detected contacts; a detection body in which a detection electrode is formed on a detection substrate facing a surface (such as a surface 40B in FIG. 2) of the protective substrate opposite to the manipulation surface of the protective substrate; and a vibrating body which is fixed to the protective substrate and which is vibrated when the object to be detected contacts the manipulation surface. In the embodiment described above, the vibrating body is fixed to the protective substrate including the manipulation surface. Therefore, for example, a user can be caused to perceive the vibrations (manipulation feeling) each having a sufficient strength as compared with the case of the construction that the vibrating body is fixed to the detection body (detection substrate). The input device according to the embodiment of the present invention can be utilized in various kinds of electronic apparatuses (such as a personal digital assistants).

Preferably, the protective substrate includes a protrusion portion which protrudes from a periphery of the detection body, and the vibrating body is fixed to the protrusion portion. Thus, since the vibrating body is fixed to the protrusion portion protruding from the periphery of the detection body, there is an advantage that the protrusion portion is hardly visually recognized by the user (a design property is maintained). Preferably, the vibrating body is fixed to a surface of the protrusion portion opposite to the manipulation surface. Thus, since the vibrating body is disposed together with the detection body on the surface of the protrusion portion opposite to the manipulation surface, the thinning of the input device is realized as compared with the case of the construction that the vibrating body is fixed to the manipulation surface. Preferably, the input device further includes a light blocking layer formed on a surface of the protrusion portion. In this construction, since the protrusion portion is not visually recognized by the user, the effect that the design property is maintained is especially remarkable.

In addition, preferably, the vibrating body is formed in a long shape along an edge side of the protective substrate. Thus, since the vibrating body is formed in the long shape along the edge side of the protective substrate, for example, the wide range of the protective substrate can be vibrated with the sufficient strength as compared with the case of the construction that the vibrating bodies are sprinkled in the corners (four corners) of the protective substrate. Preferably, the input device includes the plurality of vibrating bodies formed each in a long shape along corresponding ones of edge sides facing each other of the protective substrate. Thus, since the vibrating bodies are disposed in the corresponding ones of the edge sides facing each other of the protective substrate, for example, the strengths of the vibrations can be uniformized over the wide range of the protective substrate as compared with the case of the construction that the vibrating body is disposed only in one side of the protective substrate. In addition, preferably, the input device further includes a display body for displaying thereon an image which is installed on a side opposite to the protective substrate across the detection body.

Thus, there is an advantage that the user can make the manipulation while he/she visually recognizes the display made by the display body. It is noted that the input device including the display body can also be grasped as a display device to which an input function (a function of detecting the manipulation made by the user) is added.

According to another embodiment of the present invention, there is provided an electronic apparatus including an input device having: a protective substrate having a manipulation surface which an object to be detected contacts; a detection body in which a detection electrode is formed on a detection substrate facing a surface of the protective substrate opposite to the manipulation surface of the protective substrate; and a vibrating body which is fixed to the protective substrate and which is vibrated when the object to be detected contacts the manipulation surface.

Additional features and advantages are described herein, and will be apparent from the following Detailed Description and the figures.

### BRIEF DESCRIPTION OF THE FIGURES

FIG. 1 is an exploded perspective view of an input device according to a first embodiment of the present invention;

FIG. 2 is a cross sectional view taken in line II-II of FIG. 1;

FIG. 3 is a cross sectional view of a manipulation detecting portion in an input device according to a second embodiment of the present invention;

FIG. 4 is a top plan view showing a form of disposition of vibrating bodies according to Change 1 of each of the first and second embodiments;

FIG. 5 is a top plan view showing a form of disposition of vibrating bodies according to Change 1 of each of the first and second embodiments;

FIG. 6 is a cross sectional view showing a form of disposition of vibrating bodies according to Change 1 of each of the first and second embodiments;

FIG. 7 is a cross sectional view showing a form of disposition of vibrating bodies according to Change 1 of each of the first and second embodiments;

FIG. 8 is a cross sectional view showing a form of connection between a vibrating body according to Change 2 of each of the first and second embodiments, and an outside (control circuit);

FIG. 9 is a perspective view showing a form of a personal computer of an application example of an electronic apparatus;

FIG. 10 is a perspective view showing a form of a mobile phone of an application example of the electronic apparatus; and

FIG. 11 is a perspective view showing a form of a personal digital assistants of an application example of the electronic apparatus.

### DETAILED DESCRIPTION

Embodiments of the present application will be described below in detail with reference to the drawings.

### A. First Embodiment

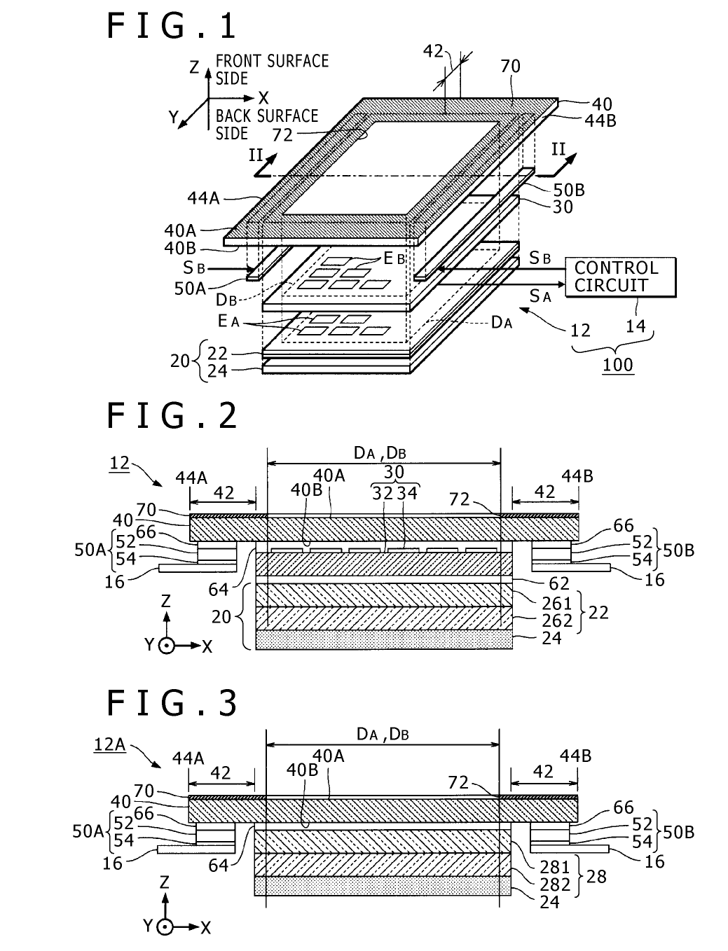

FIG. 1 is an exploded perspective view of an input device 100 according to a first embodiment of the present invention. The input device 100 is a device for detecting a manipulation made by a user, and, as shown in FIG. 1, is composed of a manipulation detecting portion 12 and a control circuit 14. The manipulation detecting portion 12 is a flat plate type touch panel having both a function of displaying thereon an image, and a function of detecting contact of an object to be detected (a hand or finger of the user). The control circuit 14 controls an operation of the manipulation detecting portion 12. Note that, in the following description, an X direction and a Y direction which are parallel with a plate surface (principal surface) of each of plate-like or layer-like constituent elements composing the manipulation detecting portion 12, and are orthogonal to each other, and a Z direction vertical to an X-Y plane are supposed for descriptive purposes. A positive side of the Z direction when viewed from an arbitrary position in the inside of the manipulation detecting portion 12 corresponds to the front surface side (the near side for the user who manipulates the input device 100). Also, a negative side of the Z direction when viewed from the position concerned corresponds to the back surface side (the back side for the user).

FIG. 2 is a cross sectional view taken on line II-II of FIG. 1. As shown in FIGS. 1 and 2, the manipulation detecting portion 12 is composed of a display body 20, a detection body 30, a protective substrate 40, and a multiple (two) vibrating bodies 50 (50A and 50B). The detection body 30 is installed on the front surface side of the display body 20, and the protective substrate 40 is installed on the front surface side of the detection body 30. Therefore, the detection body 30 is interposed in a gap defined between the display body 20 and the protective substrate 40. According to the construction that the protective substrate 40 is disposed on the front surface side of the display body 20 and the detection body 30 in the manner as described above, there is an advantage that the display body 20 and the detection body 30 are protected from being exposed to a collision of an object and an operation of an external force.

The display body 20 is composed of a display panel 22 and an illumination body 24. As shown in FIG. 2, the display panel 22 is a liquid crystal panel having a construction that a liquid crystal (not shown) is sealed in a gap defined between a light transmissive first substrate 261 and a light transmissive second substrate 262 which are joined so as to face each other. As shown in FIG. 1, multiple liquid crystal elements (pixels) EA each having a construction that the liquid crystal is interposed between electrodes facing each other are disposed in a matrix within a display area DA in the X direction and in the Y direction. The illumination body 24 is a flat plate type surface light source (backlight) disposed on the back surface side of the display panel 22. A transmittance for a light emitted from the illumination body 24 is variably controlled every liquid crystal element EA, thereby displaying a desired image within the display area DA. It should be noted that an illustration of constituent elements such as polarizing plates stuck to both surfaces of the display panel 22, respectively, is omitted here for the sake of convenience.

The detection body 30 is a light transmissive sensor for detecting approach of an object to be detected. As shown in FIG. 1, the detection body 30 is constructed as being of a flat plate type so as to include multiple detection elements EB disposed in a matric within a detection area DB in the X direction and in the Y direction. The detection body 30 is fixed to the front surface side of the display body 20 by using an adhesion layer 62 (such as an adhesive agent or a double-sided adhesive tape) shown in FIG. 2 in such a way that the display area DA and the detection area DB overlap each other from planar view (that is, when viewed from the Z direction). Although a system for detecting the object to be detected by using the detection body 30 is arbitrarily adopted, for example, an electrostatic capacitance system is suitably adopted. As shown in FIG. 2, the detection body 30 using the electrostatic capacitance system is composed of a light transmissive detection substrate 32 which is formed in a rectangular shape, and multiple detection electrodes 34. In this case, the multiple detection electrodes 34 are each made of a light transmissive conductive material, and are formed in a matrix on a surface on the front surface side of the light transmissive detection substrate 32 (on a surface of the light transmissive detection substrate 32 facing the protective substrate 40). The detection electrode 34 composes the detection element EB.

The protective substrate 40 is a rectangular substrate for protecting the display body 20 and the detection body 30. For example, a light transmissive plate-like member made of either a glass or a resin is suitably adopted as a member for the protective substrate 40. As shown in FIG. 2, the protective substrate 40 is fixed to a surface on the front surface side of the detection substrate 32 of the detection body 30 (a formation surface of the detection electrode 34) by using an adhesion layer 64 (such as an adhesive agent or a double-sided adhesive tape). The object to be detected contacts a surface 40A on the front surface side of the protective substrate 40 (hereinafter referred to as “a manipulation surface”). A detection signal SA representing an electrostatic capacitance, of each of the detection electrodes 34, which is changed in accordance with approach or contact of the object to be detected for the manipulation surface 40A is outputted from the detection body to the control circuit 14. As shown in FIGS. 1 and 2, the protective substrate 40 is larger in external dimension than each of the display body 20 and the detection body 30. Thus, the protective substrate 40 is composed so as to include a rectangular frame-like protrusion portion 42 (a portion which does not overlap the detection body 30 from the planar view) which protrudes from a periphery of the detection body 30.

A light blocking layer 70 is formed on the manipulation surface 40A of the protective substrate 40. The light blocking layer 70 is a light blocking film body in which a rectangular opening portion 72 corresponding in position to each of the display area DA of the display body 20, and the detection area DB of the detection body 30 is formed. Since each of the display area DA and the detection area DB is located inside an inner periphery of the protrusion portion 42, the protrusion portion 42 overlaps the light blocking layer 70 over the entire area.

Each of the vibrating bodies 50 (50A and 50B) is vibrated in accordance with the control made by the control circuit 14. As shown in FIGS. 1 and 2, each of the vibrating bodies 50 is fixed to a surface (that is, a surface on the back surface side of the protective substrate 40) 40B of the protrusion portion 42 of the protective substrate 40 opposite to the manipulation surface 40A of the protrusion portion 42 of the protective substrate 40. Therefore, each of the vibrating bodies 50 is located on the back surface side of the light blocking layer 70. An adhesion layer 66 (such as an adhesive agent or a double-sided adhesive tape) shown in FIG. 2, for example, is utilized for the fixing of the vibrating bodies 50 to the protective substrate 40.

The vibrating bodies 50 are each formed in a long shape so as to extend along respective edge sides of the protective substrate 40. Specifically, as shown in FIGS. 1 and 2, the vibrating body 50A extends in the Y direction along a long side 44A of the protective substrate 40. Also, the vibrating body 50B extends in the Y direction along a long side 44B of the protective substrate 40 facing the long side 44A. That is to say, the vibrating bodies 50 are disposed in parallel with each other on the surface 40B of the protective substrate 40 across the detection body 30 from each other.

As shown in FIG. 2, each of the vibrating bodies 50 (50A and 50B) of the input device 100 of the first embodiment is a piezoelectric element composed of a piezoelectric body 52 and a drive electrode 54. The piezoelectric body 52 is formed in the form of either a single layer or a lamination layer of a piezoelectric material, and is deformed (vibrated) by application of a suitable voltage. For example, the piezoelectric body 52 is made of a piezoelectric material such as a zinc oxide (ZnO) or lead zirconium titanate (PZT). The drive electrode 54 is formed on a surface of the piezoelectric body 52 on a side (back surface side) opposite to the protective substrate 40, and is composed of a positive electrode and a negative electrode through which the suitable voltage is applied across the piezoelectric body 52. Each of the drive electrodes 54 of the vibrating bodies 50 is electrically connected to the control circuit 14 through a wiring substrate 16 (such as a flexible wiring substrate) shown in FIG. 2.

The control circuit 14 shown in FIG. 1 detects presence or absence and a position of the contact of the object to be detected for the manipulation surface 40A at any time in accordance with the detection signal SA supplied thereto from the detection body 30. When the control circuit 14 detects that the object to be detected contacts the manipulation surface 40A, the control circuit 14 supplies a drive signal SB to each of the drive electrodes 54 of the vibrating bodies 50 through the wiring substrate 16. Each of the piezoelectric bodies 52 of the vibrating bodies 50 is vibrated in accordance with a voltage of the drive signal SB supplied to the corresponding one of the drive electrodes 54. Also, the vibrations of the piezoelectric bodies 52 are propagated to the manipulation surface 40A of the protective substrate 40 which the object to be detected (a hand or finger of the user) is contacting. Therefore, the user who is contacting the manipulation surface 40A of the protective substrate 40 can perceive a manipulation feeling (clicking feeling) for his/her manipulation.

In the first embodiment of the present invention, the vibrating bodies 50 are fixed to the protective substrate 40 which the user contacts in the phase of the manipulation. Therefore, the user can be caused to perceive the vibrations (manipulation feeling) each having the sufficient strength as compared with the case of the construction that the vibrating bodies 50 are fixed to the detection body 30 (the detection bodies 32). Or, a deformation amount or an applied voltage to each of the vibrating bodies 50 required to cause the user to perceive the vibrations each having the desired strength is reduced as compared with the case of the construction that the vibrating bodies 50 are fixed to the detection body 30. Therefore, it is possible to readily realize the miniaturization of the vibrating bodies 50, and the reduction of the power consumption.

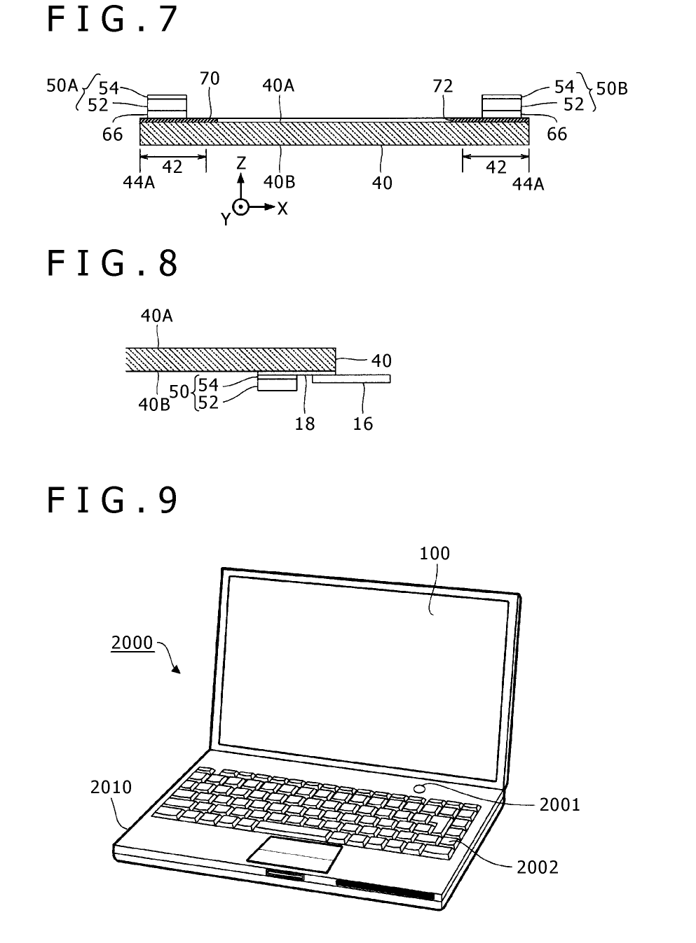

The vibrating bodies 50 are fixed to the surface 40B, of the protective substrate 40, on which the detection body 30 and the display body 20 are installed. As a result, for example, there is an advantage that the manipulation detecting portion 12 is thinned as compared with the case of the construction that the vibrating bodies 50 are fixed to the manipulation surface 40A (for example, a construction shown in FIG. 7). In addition, since the vibrating bodies 50 are fixed to the back surface side of the light blocking layer 70, the user cannot visually recognize any of the vibrating bodies 50. Therefore, the reduction of the design property (the seeming sensuousness) can be reduced as compared with the case of the construction that any of the vibrating bodies 50 are visually recognized by the user (for example, the construction that the vibrating bodies 50 are fixed to the manipulation surface 40A). It is noted that there may also be adopted the construction that the light blocking layer 70 is formed on the surface 40B, on the back surface side, of the protective substrate 40, or the construction that the provision of the light blocking layer 70 is omitted.

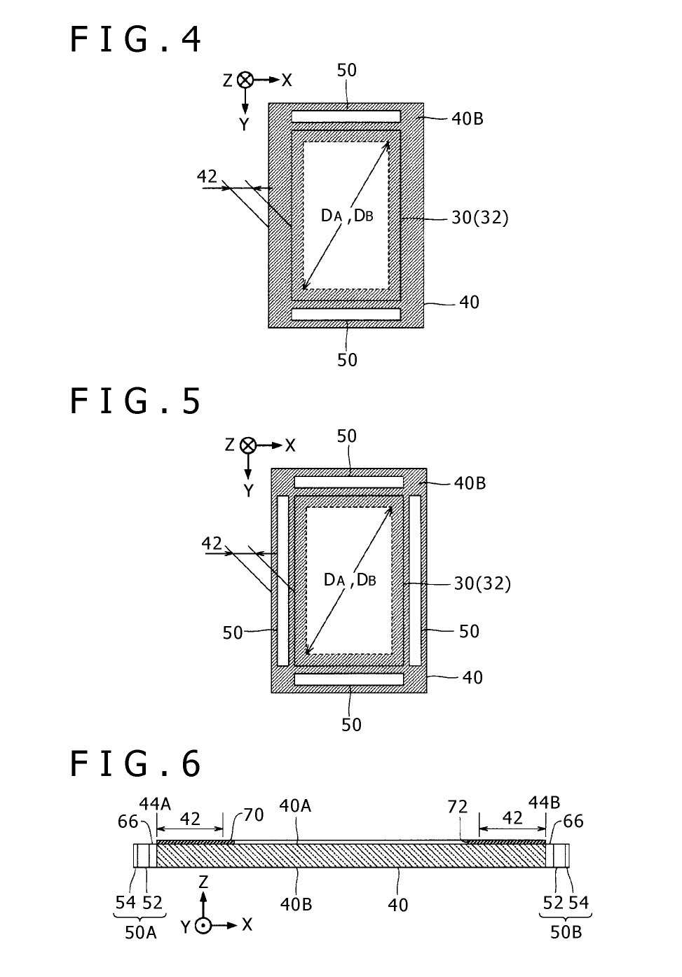

The vibrating bodies 50 are disposed so as to extend along the respective edge sides facing each other of the protective substrate 40. Therefore, the strengths (amplitudes) of the vibrations of the protective substrate 40 can be uniformized over the entire area of the detection area DB (the manipulation surface 40A) as compared with the case where the vibrating body 50, for example, is formed only in one side of the protective substrate 40. In addition thereto, since the vibrating bodies 50 are formed along the long sides 44A and 44B of the protective substrate 40, respectively, the area in which the vibrating bodies 50 are disposed can be sufficiently ensured as compared with the case where the vibrating bodies 50 are formed along the short sides of the protective substrate 40, respectively (for example, the construction shown in FIG. 4). Therefore, as compared with the case where the vibrating bodies 50 are formed along the short sides of the protective substrate 40, respectively (that is, the case where the area of the vibrating bodies 50 is restricted), there is also an advantage that the vibrating bodies 50 each of which can generate the vibrations each having the desired strength is easily disposed.

### B. Second Embodiment

Hereinafter, an input device according to a second embodiment of the present invention will be described with reference to FIG. 3. In the following description, the constituent elements which have the same operations and functions as those of the input device of the first embodiment are designated by the same reference numerals, respectively, and detailed descriptions thereof are suitably omitted here.

FIG. 3 is a cross sectional view of a manipulation detecting portion 12A of the input device according to the second embodiment of the present invention. The manipulation detecting portion 12A in the second embodiment has a construction that the display panel 22 and the detection body 30 of the manipulation detecting portion 12 in the first embodiment are replaced with a detection body (display body) 28. The detection body 28 is a (touch panel built-in) liquid crystal panel having both the function of the display panel 22 for displaying thereon an image, and the function of the detection body 30 for detecting the object to be detected. Specifically, the detection body 28 is constructed by sealing a liquid crystal (not shown) in a gap defined between a light transmissive first substrate 281 and a light transmissive second substrate 282 which are joined so as to face each other. Light transmissive detection electrodes (not shown in FIG. 3) composing a detection element EB are formed together with a liquid crystal element EA in a gap defined between the first substrate 281 and the second substrate 282. Thus, the detection signal SA corresponding to changes in electrostatic capacitances of the detection elements EB is supplied to the control circuit 14. The protective substrate 40 is fixed to the surface, on the front surface side, of the first substrate 281 of the detection body 28 by using the adhesion layer 64. The constructions of the protective substrate 40, and each of the vibrating bodies 50 are the same as those of the protective substrate 40, and each of the vibrating bodies 50 in the first embodiment.

Even with the second embodiment of the present invention described above, the same effects as those of the first embodiment are realized. In addition, the detection body 28 includes both the function of the display panel 22, and the function of the detection body 30 in the first embodiment. Therefore, there is also an advantage that the thinning of the manipulation detecting portion 12A is easily carried out as compared with the case of the first embodiment.

### C. Changes

The first and second embodiments described above can be changed into various forms. Concrete forms of Changes will be hereinafter exemplified. Two or more forms which are arbitrarily selected from the following exemplifications may be suitably merged with each other.

### (1) Change 1

Although in each of the first and second embodiments, the vibrating bodies 50 are formed in the shape so as to extend along the respective long sides of the protective substrate 40, the shapes and positions of the vibrating bodies 50 (50A and 50B) are suitably changed. For example, there may be adopted a construction that as shown in FIG. 4, the vibrating bodies 50 are disposed along respective short sides of the surface 40B, on the back surface side, of the protective substrate 40, or a construction that as shown in FIG. 5, the vibrating bodies 50 are disposed along the four sides (the two ling sides and the two short sides) of the protective substrate 40. In addition, there may also be adopted a construction that as shown in FIG. 6, the vibrating bodies 50 (50A and 50B) are disposed on respective side end surfaces of the protective substrate 40, or a construction that as shown in FIG. 7, the vibrating bodies 50 (50A and 50B) are disposed on the manipulation surface 40A of the protective substrate 40. In addition thereto, there may also be adopted a construction that only one vibrating body 50 is fixed to the protective substrate 40.

### (2) Change 2

A construction with which the vibrating bodies 50 and the control circuit 14 are electrically connected to each other is suitably changed. For example, when as shown in FIG. 8, the drive electrode 54 is formed on the surface, of the piezoelectric body 52, facing the protective substrate 40, it is preferable to adopt a construction that conduction is adapted to be made between the vibrating body 50 (the drive electrode 54) and the wiring substrate 16 through a wiring 18 formed on the surface 40B, on the back surface side, of the protective substrate 40. That is to say, the drive electrode 54 of the vibrating body 50 is electrically connected to the control circuit 14 through the wiring 18 formed on the surface 40B of the protective substrate 40, and the wiring substrate 16. The wiring 18, for example, is made of a light transmissive conductive material such as an Indium Tin Oxide (ITO). In addition, the control circuit 14 including both the function of acquiring the detection signal SA, and the function of outputting the drive signal SB is exemplified in each of the first and second embodiments. However, there may also be adopted a configuration that the circuit (detection circuit) for acquiring the detection signal SA, and the circuit (the drive circuit for the vibrating body 50) for outputting the drive signal SB are installed separately from each other.

### (3) Change 3

The form of the vibrating body 50 is arbitrarily adopted. For example, the piezoelectric element in which the drive electrodes 54 (the positive electrode and the negative electrode) are formed on the both sides of the piezoelectric body 52 may be adopted as the vibrating body 50. In addition, the vibrating body 50 is by no means limited to the piezoelectric element. For example, a vibrating body 50 in which a weight is eccentrically fixed to a rotational axis of a motor, or a vibrating body which generates vibrations by supplying a current to a coil put in a magnetic field can also be utilized for giving the vibrations to the protective substrate 40.

### (4) Change 4

The construction of the detection body 30 is suitably changed. For example, there may be adopted a construction that multiple detection electrodes 34 are formed on the surface (the surface of the detection substrate 32 facing the display body 20), on the back surface side, of the detection substrate 32. In addition, there may also be adopted a (surface type) detection body having a construction that a light transmissive detection electrode is formed over the entire area of the detection area DB (either on the front surface side or on the back surface side) of the detection substrate 32, and the presence or absence and the position of the contact of the object to be detected are specified in accordance with a relative ratio of currents detected from corner portions (four corners) of the detection electrode. In addition, the present invention can be applied to the construction as well for detecting the object to be detected by using a system (such as a resistance film system, an infrared ray system or an ultrasonic wave system) other than the electrostatic capacitance system.

### (5) Change 5

The display panel 22 (the display body 20) in each of the first and second embodiments is by no means limited to the liquid crystal panel. For example, a light emitting device in which light emitting elements such as organic Electroluminescence (EL) elements are disposed in a matrix may also be adopted as the display panel. As can be understood from the above description, the display panel in each of the above exemplifications is comprehended as an element for displaying an image by utilizing an electro-optic element (such as the liquid crystal element EA or a light emitting element) in which the optical characteristics such as a transmittance and a luminance are changed in accordance with an electrical operation such as application of an electric field or a supply of a current. It should be noted that the illumination body 24 is omitted in the case of a construction utilizing a self-emission type electro-optic element.

### D. Application Examples

The input device 100 described above can be utilized in various kinds of electronic apparatuses. FIGS. 9 to 11 show concrete forms of the electronic apparatuses each adopting the input device 100.

FIG. 9 is a perspective view showing a construction of a portable personal computer adopting the input device 100. The personal computer 2000 includes the input device 100 which displays thereon an image and which detects the contact of the object to be detected for the manipulation surface 40A, and a main body portion 2010 in which a power source switch 2001 and a keyboard 2002 are installed.

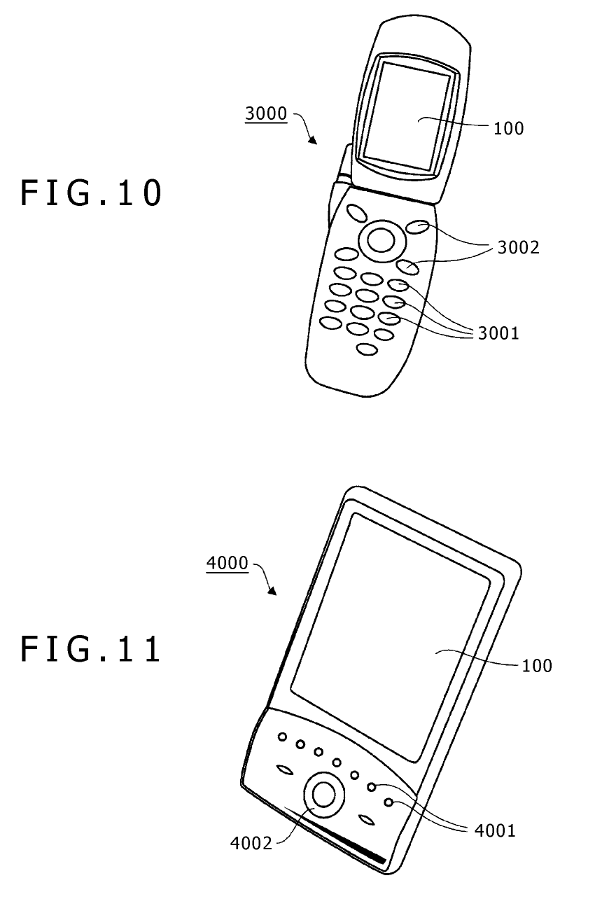

FIG. 10 is a perspective view showing a construction of a mobile phone to which the input device 100 is applied. The mobile phone 3000 includes multiple manipulation buttons 3001, multiple scroll buttons 3002, and the input device 100 which displays thereon an image and which detects the contact of the object to be detected for the manipulation surface 40A. When the manipulation surface 40A of the input device 100 or the scroll buttons 3002 are manipulated, a picture displayed on the input device 100 is scrolled.

FIG. 11 is a perspective view showing a construction of a Personal Digital Assistants (PDA) to which the input device 100 is applied. The PDA 4000 includes multiple manipulation buttons 4001, a power source switch 4002, and the input device 100 which displays thereon an image and which detects the contact of the object to be detected for the manipulation surface 40A. When the manipulation surface 40A of the input device 100 and the power source switch 4002 are manipulated, information stored in an address list, an appointment book, or the like is displayed on the input device 100.

It is noted that in addition to the electronic apparatuses 2000, 3000 and 4000 shown in FIGS. 9 to 11, respectively, a projector, a digital still camera, a television set, a video camera, a car navigation system, an in-car display device (instrument panel), an electronic databook, an electronic paper, an electronic calculator, a word processor, a work station, a TV telephone, a POS terminal, a printer, a scanner, a copy machine, a video player, an apparatus including a touch panel, and the like are given as the electronic apparatuses to each of which the input device 100 according to the embodiments of the present invention is applied.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An input device, comprising:
a protective substrate having a manipulation surface which an object to be detected contacts;
a detection body in which a detection electrode is formed on a detection substrate facing a surface of said protective substrate opposite to said manipulation surface of said protective substrate; and
a vibrating body which is fixed to said protective substrate and which is vibrated when said object to be detected contacts said manipulation surface.

2. The input device according to claim 1, wherein said protective substrate includes a protrusion portion which protrudes from a periphery of said detection body, and said vibrating body is fixed to said protrusion portion.

3. The input device according to claim 2, wherein said vibrating body is fixed to a surface of said protrusion portion opposite to said manipulation surface.

4. The input device according to claim 2, further comprising
a light blocking layer formed on a surface of said protrusion portion.

5. The input device according to claim 1, wherein said vibrating body is formed in a long shape along an edge side of said protective substrate.

6. The input device according to claim 1, wherein said input device includes the plurality of vibrating bodies formed each in a long shape along corresponding ones of edge sides facing each other of said protective substrate.

7. The input device according to claim 1, further comprising
a display body for displaying thereon an image which is installed on a side opposite to said protective substrate across said detection body.

8. An electronic apparatus comprising an input device having:
a protective substrate having a manipulation surface which an object to be detected contacts;
a detection body in which a detection electrode is formed on a detection substrate facing a surface of said protective substrate opposite to said manipulation surface of said protective substrate; and
a vibrating body which is fixed to said protective substrate and which is vibrated when said object to be detected contacts said manipulation surface.
